(19) United States
(12) Patent Application Publication
(10) Pub. No.: US 2021/0231410 A1
(43) Pub. Date: Jul. 29, 2021

(54) BALLISTIC BODY ARMOR AND METHOD OF MANUFACTURING

(71) Applicant: University of Massachusetts, Boston, MA (US)

(72) Inventors: Armand F. Lewis, Mattapoisett, MA (US); Yong K. Kim, North Dartmouth, MA (US)

(21) Appl. No.: 17/082,177

(22) Filed: Oct. 28, 2020

Related U.S. Application Data
(63) Continuation-in-part of application No. 15/706,962, filed on Sep. 18, 2017, now Pat. No. 10,820,655.
Application No. 15/706,962 is a continuation-in-part of application No. 15/100,674, filed on Jun. 1, 2016, now Pat. No. 9,788,589.
Application No. 15/100,674 is a continuation-in-part of application No. 15/942,770, filed on Apr. 2, 2018.
Application No. 15/942,770 is a continuation-in-part of application No. 14/642,987, filed on Mar. 10, 2015, now abandoned.
(60) Provisional application No. 62/930,841, filed on Nov. 5, 2019.
(60) Provisional application No. 61/911,180, filed on Dec. 3, 2013.
(60) Provisional application No. 61/924,426, filed on Jan. 7, 2014.
(60) Provisional application No. 61/932,930, filed on Jan. 29, 2014.

(51) Int. Cl. F41H 5/04; B32B 5/02; B32B 7/12; B32B 5/26

(52) U.S. Cl. CPC F41H 5/0478; B32B 5/022; B32B 7/12; B32B 5/024; B32B 5/275; B32B 2260/021; B32B 2571/02; B32B 2262/0261; B32B 2262/0276; B32B 2305/55; B32B 2260/046; B32B 2307/558

(57) ABSTRACT

An impact energy dissipating fabric system includes a strike-face layer formed using a Z-axis flock fiber reinforced Organic Polymer Laminar Composite (OPLC), an energy absorbing core media layer attached adjacent the strike-face layer and formed using Foam Impregnated Flocked (FIF) layers and an Against The Body (ATB) Layers including Flocked Energy Absorbing Material (FEAM) attached adjacent to the energy absorbing core media layer and the layers are disposed on one another and coupled together with an adhesive, sewing or quilting.

### RELATED APPLICATIONS

This application claims the benefit of U.S. Provisional Application No. 62/930,841, entitled BALLISTIC BODY ARMOR AND METHOD OF MANUFACTURING and filed Nov. 5, 2019. This application is a continuation in part of U.S. application Ser. No. 15/706,962, entitled ADD-ON IMPACT ENERGY ABSORBING PAD STRUCTURE FOR OUTSIDE OF MILITARY AND SPORT HELMETS UMD13-01CIP, filed Sep. 18, 2017, now U.S. Pat. No. 10,820,655 issued Nov. 3, 2020 which application is a Continuation in part of U.S. application Ser. No. 15/100,674, filed Jun. 1, 2016, Attorney Docket UMD13-01, entitled FLEXIBLE, FIBROUS ENERGY MANAGING COMPOSITE PANELS now U.S. Pat. No. 9,788,589, issued Oct. 17, 2017; which is a National Stage Entry (371) of US Application No. PCT/US2014/067883, entitled FLEXIBLE, FIBROUS ENERGY MANAGING COMPOSITE PANELS, filed Dec. 1, 2014; which claims the benefit of U.S. Provisional Application No. 61/911,180, entitled FLEXIBLE, FIBROUS ENERGY MANAGING COMPOSITE PANELS, filed Dec. 3, 2013 and U.S. Provisional Application No. 61/924,426, entitled FLOCKED ELECTRO-ACTIVE SENSING (FEAS) MATERIALS AND ENERGY GENERATING DEVICES, filed Jan. 7, 2014 and U.S. Provisional Application No. 61/932,930, entitled Integrally Flocked, Impact Absorbing Outside Covering System for Sport Helmets, filed Jan. 29, 2014; this application is also a continuation in part of U.S. application Ser. No. 15/942,770, Filed Apr. 2, 2018, entitled STRENGTH ENHANCING LAMINAR COMPOSITE MATERIAL PLY LAYER PRE-FORM AND METHOD OF MANUFACTURING THE SAME which is a continuation in part of U.S. patent application Ser. No. 14/642,987, filed on Mar. 10, 2015, entitled STRUCTURED FIBER REINFORCED LAYER, which applications are hereby incorporated herein by reference in their entireties.

### FIELD OF THE INVENTION

The invention relates to the use of Z-axis flock fiber reinforced Organic Polymer Laminar Composites (OPLC), Foam Impregnated Flocked (FIF) layers and Flocked Energy Absorbing Material (FEAM) in systems for stopping projectiles and absorption and dissipation of impact energy, the assembly of such systems and more specifically to the use of these systems in flexible ballistic body armor.

### BACKGROUND

Personal (wearable) body armor is now a common and realistic component in today's military and law enforcement communities. The epidemic of gun violence in the US is at an all-time high and the use of Ballistic (protection) Body Armor (BBA) by police and first responder personnel in now standard procedure.

From a basic standpoint, Ballistic (protection) Body Armor is generally composed of three functional material layers:

Strike-Face, a projectile strikes this material first usually includes a hard, plate-like material whose function is to seriously deflect, distort, absorb the majority of the bullet impact kinetic energy, drastically slow the velocity of the projectile.

Energy Absorbing Core Media, an impact energy absorbing material layers that gradually (through-thickness) absorbs the remaining bulk of the impacting projectile kinetic energy remaining after Strike-Face impact energy is absorbed. This layer is generally the “back-up” energy absorbing media for the strike-face material component.

Against The Body (ATB) Layer, an ATB material layer of a BBA configuration functionally absorbs, distributes and prevents the projectile's (residue) kinetic energy impact from causing pain and injury to the wearer of the BBA garment. It is the final “line of defense” for the wearer. This layer minimizes the against-the-body (human body damaging) impact energy level experienced by the wearer of the BBA garment and provides wearer.

Conventional ballistic body armor garments are uncomfortable for the wearer because they are somewhat non-conformable Against-The-Body (ATB) because they are not adaptable to being sweat absorbing and breathable. Present body armor garments are not designed to dissipate body heat, and have a poor ability to manage body sweat. Many of the existing personal BBA garments are thick, heavy, rigid, bulky, cumbersome, non-conformable and are wearer uncomfortable (e.g., do not breathe and effectively absorb sweat). The field of ballistic body armor garments and pads is growing rapidly. Due to homeland security issues and domestic and military needs, there presently happens to be a world-wide shortage of ballistic body armor garments.

### SUMMARY

In one embodiment an impact energy dissipating fabric system includes a strike-face layer comprising a Z-axis flock fiber reinforced Organic Polymer Laminar Composite (OPLC), an impact energy absorbing (IEA) core media layer attached adjacent the strike-face layer and an Against-The-Body (ATB) layer attached adjacent the impact energy absorbing core media layer. Such a system combines impact energy absorption, pad thinness and impact force absorbing (IFA) properties with flexible Ballistic Body Protection panel materials to provide a “velvety” smooth (by a flocked surface) to the touch, against the (skin) body surface texture.

In another embodiment, the Z-axis flock fiber reinforced OPLC includes a plurality of layers of ballistic impact resistant fabric in a resin matrix including epoxy, a polyurea resin, a polyurethane resin or a polyurea/polyurethane hybrid. In another embodiment, the plurality of layers of ballistic impact resistant fabric in a resin matrix are separated into a plurality of slats of Z-axis flock fiber reinforced OPLC, the strike-face layer further includes a fabric base layer attached adjacent to the plurality of slats of Z-axis flock fiber reinforced OPLC in a closely spaced arrangement to provide flexibility and directional conformability. In another embodiment, the plurality of layers of ballistic impact resistant fabric include spun yarn fabric of liquid crystal polymer (LCP).

In another embodiment, the impact energy absorbing (IEA) core media layer includes at least one Foam Impregnated Flocked (FIF) layer including a plurality of flock fibers embedded in an energy absorbing, flexible foam matrix. In further embodiments, the Foam Impregnated Flocked (FIF) layer includes flock fibers having a denier in a range of about 2 to 100 and a length of about 1 to 4 mm long and the flock fibers include nylon fibers or polyester fibers.

In another embodiment, the impact energy absorbing (IEA) core media layer includes at least one layer of polyolefin based ballistic impact resistant fabric.

In another embodiment, ATB layer includes a flocked velvety faced fabric panel, a separator fabric layer disposed adjacent the flocked velvety faced fabric panel, at least one single sided flocked fabric layer disposed adjacent to the separator fabric layer and one side of a hook layer or loop attachment system disposed adjacent the at least one single sided flocked fabric layer. In a further embodiment, the at least one single sided flocked fabric layer includes a Flocked Energy Absorbing Material (FEAM) panel comprising flock fibers having a denier of about 45 to 100 and length of about 1-4 mm flock fibers flocked on a plain weave fabric base.

In another embodiment, the impact energy dissipating fabric system is assembled into protection equipment selected from the group consisting of vests, helmets, body armor, knee pads, footwear, vehicle lining, casings and other types of protective linings for a human body, electronics and other goods, abrasion resistant gear, impact resistant gear and trauma gear.

A technique for making an impact energy dissipating fabric system includes assembling a strike-face layer comprising a Z-axis flock fiber reinforced Organic Polymer Laminar Composite (OPLC), assembling an impact energy absorbing (IEA) core media layer, attaching the IEA core media layer to the strike-face layer, assembling an Against-The-Body (ATB) layer and attaching the ATB layer adjacent to the IEA core media layer. Attaching the IEA core media layer to the strike-face layer includes adhesively bonding the IEA core media layer to the strike-face layer or attaching the IEA core media layer to the strike-face layer with a hook and loop attachment system and then fastening the strike-face layer and the IEA core media layer together. The technique further includes attaching the ATB layer adjacent to the IEA core media layer including adhesively bonding the IEA core media layer to the ATB layer or attaching the IEA core media layer to the ATB layer with a hook and loop attachment system, and fastening the strike-face layer, ATB layer and the IEA core media layer together. Assembly, consolidation and finalizing this three layer material structure can also be accomplished by perimeter sewing and loose center through-panel “quilting.”

The technique of assembling a strike-face layer comprising a Z-axis flock fiber reinforced Organic Polymer Laminar Composite (OPLC) includes flocking a plurality of ballistic impact resistant fabric layers, applying a resinous matrix material to the plurality of flocked ballistic impact resistant fabric layers, curing the resinous matrix material, cutting the plurality of flocked ballistic impact resistant fabric layers into a plurality of slats, arranging or mounting the plurality of slats closely together side by side; and bonding the plurality of slats to a base fabric. The technique of bonding the plurality of slats to a base fabric includes bonding the plurality of slats to the base fabric with an elastomeric adhesive.

The technique of assembling a strike-face layer comprising a Z-axis flock fiber reinforced Organic Polymer Laminar Composite (OPLC) includes separating the plurality of slats to provide flexibility and directional flexibility and conformability. With such a technique, the zones between the slats must directionally flexible.

The technique of assembling an ATB layer includes flocking a fabric base to make a flocked velvet panel, attaching a separator fabric layer to the flocked velvet panel, flocking at least one single sided flocked fabric layer and attaching the at least one single sided flocked fabric layer to the separator fabric layer, the separator fabric layer disposed between the flocked velvet panel and at least one single sided flocked fabric layer. A further technique includes attaching one side of a hook or loop attachment system adjacent the at least one plain weave fabric layer. In one embodiment, the single sided flocked fabric layer includes a flocked plain weave fabric base.

The technique of assembling an impact energy absorbing (IEA) core media layer includes providing a flocked fabric having a flocked surface, mixing a foam resin to provide a rapidly expanding and curing foam, impregnating the flocked surface with the rapidly expanding and curing foam and processing the rapidly curing foam such that the core media layer has a fairly uniform thickness.

In another embodiment, an impact energy dissipating fabric system includes an Against-The-Body (ATB) layer attached adjacent the impact energy absorbing core media layer including a flocked velvety faced fabric panel, a separator fabric layer disposed adjacent the flocked velvety faced fabric panel, at least one single sided flocked fabric layer disposed adjacent to the separator fabric layer and one side of a hook and loop attachment system disposed adjacent the at least one single sided flocked fabric layer.

Various embodiments including Z-axis flock fiber reinforced Organic Polymer Laminar Composites (OPLC), Foam Impregnated Flocked (FIF) layers and Flocked Energy Absorbing Material (FEAM) for ballistic body armor are described herein. When these materials are combined, the resulting ballistic body armor has excellent impact energy absorption and impact force absorbing properties. The armor is relatively thin, light weight and provides a smooth to the touch, against the body surface texture that is breathable so that it is comfortable to the wearer. Methods for assembling the ballistic body armor are also provided.

### BRIEF DESCRIPTION OF THE DRAWINGS

The foregoing and other objects, features and advantages of the invention will be apparent from the following more particular description of embodiments of the invention, as illustrated in the accompanying drawings and figures in which like reference characters refer to the same parts throughout the different views. The drawings are not necessarily to scale, with emphasis instead being placed upon illustrating the embodiments, principles and concepts of the invention. These and other features of the invention will be understood from the description and claims herein, taken together with the drawings of illustrative embodiments, wherein:

FIG. 1 is a schematic diagram of a multi-component ballistic body armor (BBA) panel in accordance with one example embodiment disclosed herein;

FIG. 2A is a schematic diagram of a multi-layer Strike Face Configuration ballistic impact resistant fabric component in a resin matrix in accordance with one example embodiment disclosed herein;

FIG. 2B is a schematic diagram of the multi layer Strike Face Configuration of FIG. 2A cut into slats;

FIG. 2C is a schematic diagram of composite slats of FIG. 2B mounted and adhered onto a fabric base layer using an elastomeric adhesive coating in accordance with one example embodiment disclosed herein;

FIG. 2D is a schematic top edge view of the flexible/bendability at junctions between the OPLC slats adhered to a fabric base of FIG. 2C in accordance with one example embodiment disclosed herein;

FIG. 3A is a schematic diagram of an impact energy absorbing (IEA) core media layer including a Foam Impregnated Flocked (FIF) layer coated onto a flocked fabric layer in accordance with one example embodiment disclosed herein;

FIG. 3B is a schematic diagram of an impact energy absorbing (IEA) core media layer including the Foam Impregnated Flocked (FIF) layer of FIG. 3A after smoothing and leveling off the surface processing of the foam;

FIG. 3C is a schematic diagram of an impact energy absorbing (IEA) core media layer including a multi layer ballistic impact resistant fabric stacked arrangement in accordance with one example embodiment disclosed herein;

FIG. 4 is a schematic diagram of an Against the Body (ATB) Panel for BBA Application in accordance with one example embodiment disclosed herein;

FIG. 5A is a graph of Force Loss (%) properties of FIF panel layers and standard configuration panels at Various GWD Drop Heights in accordance with example embodiments disclosed herein; and

FIG. 5B is a graph of Force Loss (%) properties of no-foam FEAM configuration panels at Various GWD Drop Heights in accordance with example embodiments disclosed herein.

### DETAILED DESCRIPTION

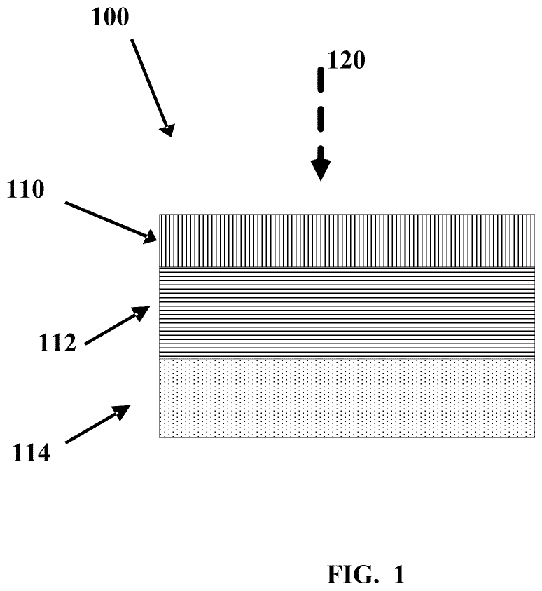

In embodiments described below two technologies and new materials are applied to address the deficiencies of conventional Ballistic Body Armor (BBA) configurations. These technologies are (a) Z-Axis (flock fiber) reinforced Organic Polymer Laminar Composites (OPLC) and (b) Flocked Energy Absorbing Material (FEAM). Embodiments include (a) the application of Z-Axis (flock fiber) OPLC reinforcement technology to “Strike-Face” materials component, (b) the application of new materials concepts to greatly enhance the Energy Dissipating “Core” part of the BBA garment and (c) the application of FEAM technology to the Against The Body (ATB) layer of the BBA system. FIG. 1 shows the material components (e.g., three layers) of a ballistic body armor panel.

Now referring to FIG. 1, an exemplary Ballistic Body Armor (BBA) panel 100 includes a strike-face layer comprising a Z-axis flock fiber reinforced Organic Polymer Laminar Composite (OPLC) 110, an impact energy absorbing (IEA) core media layer 112 attached adjacent the strike-face layer 110, and an Against-The-Body (ATB) layer 114 attached adjacent the impact energy absorbing core media layer 112. Arrow 120 indicates a bullet or projectile strike against the BBA panel 100. The Z-axis flock fiber reinforced Organic Polymer Laminar Composite (OPLC) 110 is in one embodiment a hard material composite. The impact energy absorbing (IEA) core media layer 112 is generally a thicker layer than layer 110 and layer 114. The Against-The-Body (ATB) layer 114 is generally a breathable, comfortable and light weight layer. The Z-axis flock fiber reinforced Organic Polymer Laminar Composite (OPLC) 110 uses Pre-Flocked OPLC fabric layers. The Z-Axis (flock fiber) reinforcement material increases the OPLC's impact toughness in one embodiment by over 20 percent. The Z-Axis reinforcement relates to high-strain, destructive, irreversible material destruction Impact Energy or Force Absorbing material properties and dramatically increases the interlaminar shear strength and fracture toughness of OPLC materials.

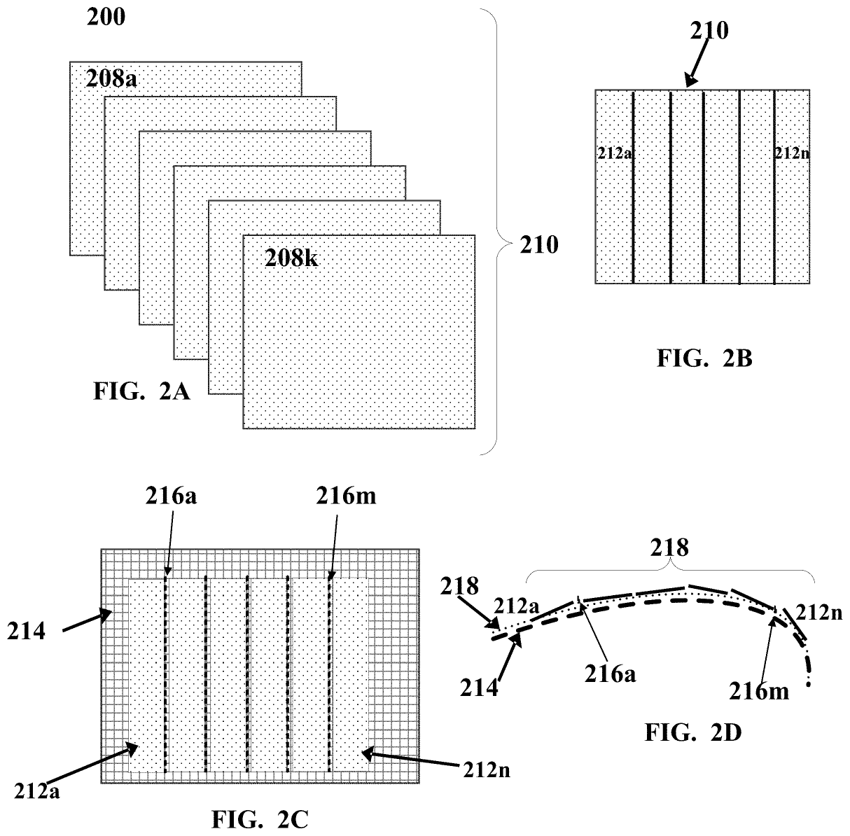

Now referring to FIG. 2A, the Z-axis flock fiber reinforced Organic Polymer Laminar Composite (OPLC) 110 Strike Face includes a plurality of layers of ballistic impact resistant fabric 210a-210k (collectively referred to as ballistic impact resistant fabric 210) in a resin matrix including, for example, epoxy or polyurethane resin. In one embodiment five layers of ballistic impact resistant fabric are used. Further details about OPLC materials can be found in U.S. Pat. No. 9,788,589 which has been incorporated by reference. In various embodiments the materials used for the ballistic impact resistant fabric, include but are not limited to high impact energy absorbing fabric/fibrous materials, for example, Vectran®, Kevlar®, Spectra®, Dyneema® and Zylan®. In one particular embodiment, the ballistic impact resistant fabric 210 is prepared employing the lay-up of five (5) layers of a spun yarn fabric of liquid crystal polymer (LCP) (e.g., Vectran® fabric) using (1) Amine Cured Epoxy resin as matrix or (2) Hanson Group's PolyArmor CRD 8003 matrix resin. The composite lay-up is finally cured and cut into closely arranged side by side slats and assembled to form a directionally conformable Strike-Face structure as described below in conjunction with FIGS. 2B-2D.

Now referring to FIG. 2B, the ballistic impact resistant fabric 210 is cut into slats 212a-212n (collectively referred to as slats 212) after being laid up in the matrix resin. The composite lay-up is cured and stiff and in its final structural form when it is cut into slats. FIG. 2C shows the slats 212 arranged closely spaced on a fabric base layer 213 to provide flexibility and directional conformability. FIG. 2D shows the flexibility and directional conformability of the closely arranged slats 212. In one embodiment, the slats 212 are bonded to a base fabric using an elastomeric adhesive 218 which also at least partially fills the space 216a-216m between the slats. In one embodiment the base fabric 214 is also a ballistic impact resistant fabric.

In one embodiment, the Z-axis flock fiber reinforced Organic Polymer Laminar Composite (OPLC) 110 Strike Face includes five layers of Vectran® Fabric using PolyArmor CRD 8003 resin as matrix and the slats are cut into two inch wide slats and adhered to a single layer of Vectran® fabric using an Elastomeric Flexible adhesive coating. PolyArmor CRD 8003 is a liquid, two-part polyurethane molding and casting system made by the Hanson Group LLC. Vectran is a manufactured fiber, spun yarn from a liquid crystal polymer (LCP) created by Celanese Corporation and now manufactured by Kuraray.

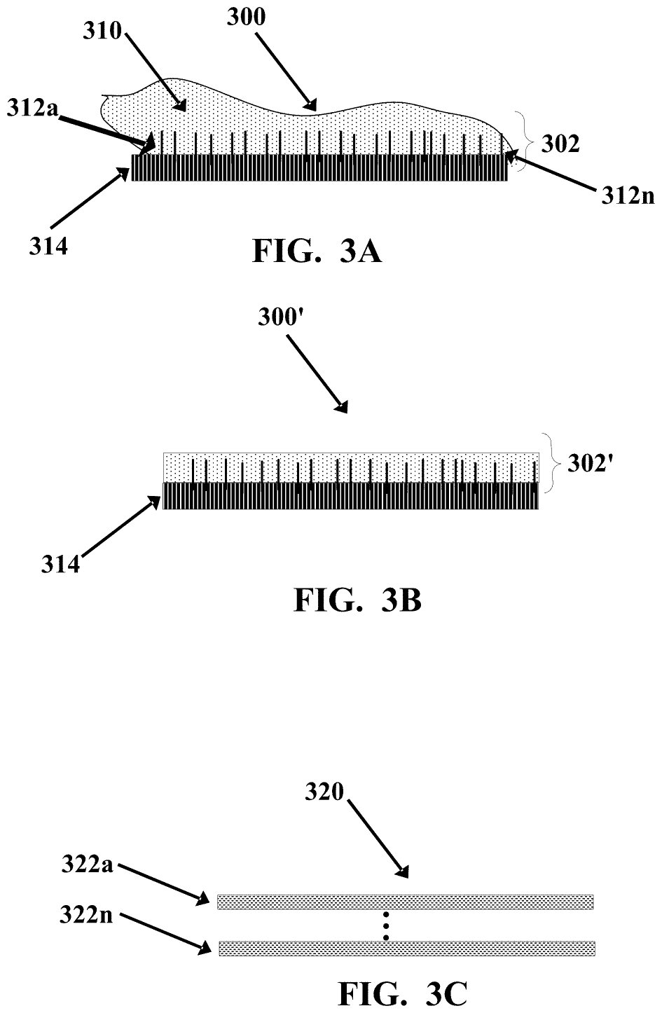

Now referring to FIG. 3A, in one embodiment an impact energy absorbing (IEA) core media layer 300 includes a Foam Impregnated Flocked (FIF) layer 302 having a plurality of flock fibers 312a-312n flocked onto a fabric 314 that is impregnated with an energy absorbing, flexible foam matrix 310. This impact energy absorbing (IEA) core media layer is resilient and has a high capacity for absorbing impact energy at a wide range of projectile impact velocities. This secondary (back-up to the strike-face) “core” media has multiple modes of impact energy absorption. In one embodiment, the IEA core media layer 300 is a specially modified FEAM-structure employing the concept of flocked surfaces whose flock fibers 312a-312n have been impregnated with the energy absorbing, low density flexible foam matrix 310.

In various embodiments, three different two part polyurethane foam materials obtained from Reynolds Advanced Materials were used: FlexFoam-iT® Formulations—(1) 17; (2) 7FR and (3) IV. In these embodiments, the (IEA) core media layer 300 was prepared by applying the (mixed) foam formulation to a flocked fabric material. An exemplary flocked fabric has a composition using a 100 denier, 2.5 mm long flock fiber. The two-part Reynolds Foams underwent a very rapid (almost uncontrollable) foaming action once the two parts of the resin are mixed. To accommodate this behavior, immediately after the mixed foam formulation is applied to the flocked fabric FIF layer 302 (i.e., impregnated into the flock fibers), the FIF layer is consolidated by putting the rapidly curing sample in a flat press assembly. This procedure enables fabricating a reasonably flat surfaced, fairly uniform thickness the IEA core media layer 300. FIG. 3B shows the IEA core media layer after processing the rapidly curing foam (e.g., removing the excess foam by a suitable scraping procedure) such that FIF layer 302′ and the core media layer 300′ have a fairly uniform thickness.

In another embodiment, shown in FIG. 3C, an impact energy absorbing (IEA) core media layer 320 includes multiple layers 322a-322n of ballistic impact resistant fabric in a stacked arrangement. In one embodiment, the ballistic impact resistant fabric is a polyolefin based fabric.

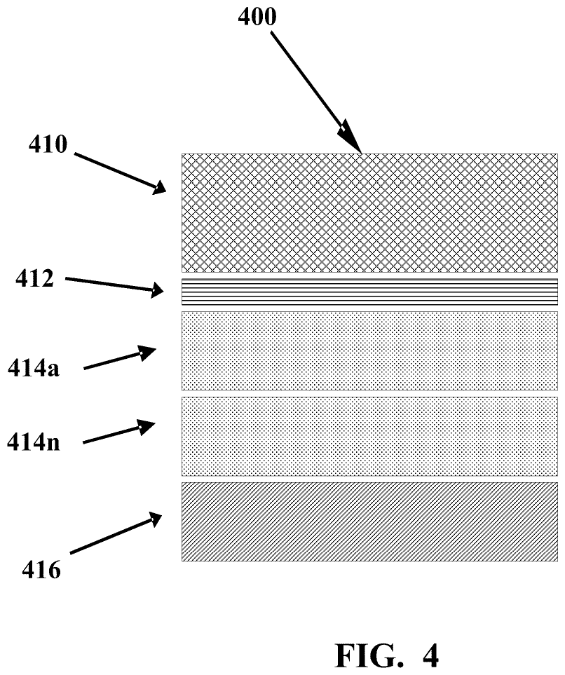

Now referring to FIG. 4, an Against-The-Body (ATB) layer ATB layer 400 includes a flocked velvety faced fabric panel 410, a separator fabric layer 412 disposed adjacent the flocked velvety faced fabric panel 410, at least one single sided flocked fabric layer shown here as two layers 414a-414n disposed adjacent to the separator fabric layer 412 and one of a hook layer or loop layer 416 disposed adjacent the at least one single sided flocked fabric layer 414n. The ATB layer is important for several reasons. It is designed to (a) Protect the human body from the travelling, destructive stress wave that accompanies a projectile's overall impact to a BBA garment; (b) absorb impact energy; (c) distribute the impact stress wave over a larger area of the interior (against the body) layer of the BAA; (d) Adjust to mild body contour; (e) be comfortable against the skin and body and (f) be breathable and dissipate/manage body heat and sweat. The FEAM construction of the ATB layer structure provides excellent impact energy absorption results as shown below in Table 1: Guided Weight Drop (GWD) Impact Energy Absorption Data for Various Against the Body (ATB) Ballistic Body Armor Panels.

Again referring to FIG. 4, the following fabric components were used in one embodiment (designated ATB 053-A):
(a) Velvet flocked (dull green):FX1 362-2S (“Dull Green” “velvet” flocked panel back flocked with 136 denier, 2 mm long nylon fiber)
(b) Gray “separator” fabric Light weight, plain weave, “liner fabric”-polyester.
(c) Single-Side Flocked Fabric (60 to 80 denier, 2 mm long flock fiber on a plain weave fabric base).
(d) Another layer of above flocked fabric.
(e) WW1733 (Velcro(& hook adaptable):FX1362-25 (Black Velcro® hook adaptable fabric whose back side is flocked with 2 mm long, 136 denier, nylon flock fiber).

As shown in FIG. 1, the impact energy absorbing (IEA) core media layer 112 is separate from the Against-The-Body (ATB) layer 114. In one embodiment the ATB layer 400 is used to make an independent garment “Liner” which can be worn under existing Bullet-Proof Ballistic Armor Garments. The independent garment Liner would be a stand-alone wearable garment which is sold and used separately from a BBA garment The stand-alone garment is fabricated using the ATB material configuration described in FIG. 4.

### Additional Embodiments and Test Results

In one embodiment, a 14″×13½″×13.2 mm (thick) type 049-A ATB panel was fabricated, and this panel was labeled 053-A. This fabricated panel was measured to have an areal density of 0.55 lbs/ft2 (2688 g/sq. meter). One process in this fabrication is the use of hot melt (glue-gun) adhesive spots that were randomly and sparsely distributed between the layers to hold the multiple layers of assembled components together while sewing or fastening. In other embodiments water based adhesive (e.g., Liquid Stitch) was used instead of hot melt (glue-gun) adhesive spots. This “spot bonding” served to consolidate these relatively large area FEAM panels and greatly facilitates the final sewing or fastening of lay-up's perimeter. This adhesive bonding/stitching also helps to keep the larger-than-normal FEAM panel together while being flexed (“bagging” of the fabric is mitigated). In yet another embodiment, a seam is sewn through the bulk area of the panel. However, it was found that sewn (quilted) seams in FEAM panels lower their IEA properties. The use of adhesives to consolidate large area FEAM panels was determined to be a preferred method. It is understood that final ballistic body armor products might be fabricated by conventional means using panels made using embodiments disclosed herein.

### Source of Materials Used

Sources of some of the materials used to manufacture embodiments disclosed herein are listed below:
WW1733 (Black) Velcro® hook adaptable base fabric; Gehring-Tricot, Inc, Garden City, N.Y.
Divider or Separator fabric JoAnn Fabrics plain weave 100% polyester “lining fabric”

### Casa Collection Solid Lining Fabric; Item #ZPRD_09645771 A

“Velvet” soft flocked surface base fabric WW1733 back flocked with nylon flock fiber back-flocked by Spectro Coatings.
Single-Side Flocked Fabric—Flocked onto a Pellon 50 type 100% polyester nonwoven fabric (or alternatively 100% PET nonwoven fabric) as the base.

In one embodiment the flock fibers have a stiffness of about 100 Denier, 1 to 4 mm long Nylon flock FEAM components on the outer side Velcor® hook adaptable outer layer side of the panel. Central Cores (i.e., the Energy Dissipating “Core” Media) of these BBA panels use Nylon flock fibers having 2 to 100 Denier and a length of 1 to 4 mm long. The FEAM panels in the Against-The-Body (ATB) layers are about 45 to 80 Denier, 1-4 mm long Nylon Flock fibers.

This is generally what seems to work best for the Against-The-Body (ATB) panels. In other embodiments the flock fibers include nylon, polyester, polyimide fibers.

### Test Methodology

A GWD (Guided Weight Drop) test involves gravity-dropping a 5 Kg hemi-spherically strike-faced shaped steel mass from a specified height (in this case 100 cm or 1 meter) onto a solid flat platform mounted FEAM IEA test panel. The base of this GWD apparatus is electronically fitted with sensing devices that measure the force absorbed by the FEAM IEA test sample as well as the 5 Kg mass's “deceleration” value (“g”) and force lost percentage (FL %).

### Test Results

Table 1 lists the GWD data in order of increasing Areal Density (lbs/ft²). Upon review, there seems to be a slight trend indicating that the higher areal density panels have the higher IEA, and corresponding higher impact force absorbing (IFA), properties. This is not too critical since the overall areal density range studied was quite narrow; 0.43 to 0.68 lbs/ft².

In summary embodiments 043-A and 049-A seem to be the best choices to use for the ATB layers sections of the ballistic body armor pad design. It is noted here that the best IEA performing panel, 043-A, employs a FEAM graduated stiffness layer assembly technique where IFA performance is enhanced by stacking various stiffness FEAM layers together such that the stiffest FEAM panel is closest to a Strike-face layer (first layer struck by an impacting projectile). The next back-up layers are placed in the assembled sequence such that the layers stiffness is graduated from stiffer (harder) to softer (more easily compressed). It is noted that sample 043-A was also the thickest ATB embodiment tested. The 049-A embodiment is much thinner than the better IEA performing embodiment 043-A. In this embodiment, thinness was considered a more important feature than IEA properties.

TABLE 1
Guided Weight Drop (GWD) Impact Energy Absorption Data for Various
Against the Body (ATB) Ballistic Body Armor Embodiments

| | | | Areal | | |
|---|---|---|---|---|---|
| Lab | | Thickness | Density | “g” | FL % |
| ID | Description (a) | (mm) | (lbs/ft²) | (100 cm) | (100 cm) |
| 043-A | WW1733/FX1002-3D/FX602- | 18.6 | 0.68 | 71.5 ± 3.2 | 52.8 ± 3.0 |
| | 3S/FX452-3S//FX452-3S “velvet” | | | | |
| | topped (military brown) | | | | |
| 043-B | WW1733/FX452-2S/FX452- | 14.4 | 0.43 | 91.8 ± 1.7 | 31.8 ± 1.6 |
| | 3D//FX452-3S “velvet” topped | | | | |
| | (military brown) | | | | |
| 042-A | WW1733:FX136-2S//FX801- | 10.9 | 0.51 | 91.7 ± 2.5 | 34.7 ± 2.8 |
| | 2D//FX801-3S: “velvet” topped (dull | | | | |
| | green). | | | | |
| 042-C | WW1733:FX1362-2S/FX1362- | 14.5 | 0.52 | 83.3 ± 4.0 | 43.4 ± 3.5 |
| | 2S/FX1362-2S//FX602-3S:GT-SHR | | | | |
| | 758 | | | | |
| 049-A | WW1733:FX1362-2S/Single | 13.1 | 0.60 | 80.7 ± 4.4 | 46.0 ± 3.9 |
| | Flock/Single Flock//FX801-3S:dull | | | | |
| | green “velvet” | | | | |

| | |
|---|---|
| Base Strike Force (no test sample) Newtons | 6008 +/− 67 |

WW1733 is the Gehring-Trico Velcro® hook adaptable fabric.
Panels 049-A and 049-B were specially prepared ATB configurations.
In Table 1, the follow nomenclature is used for a laid-up assemble of the following layers, for example:

### WW1733/FX1002-3D/FX602-3S/FX452-3S//FX452-3S

WW1733—this is a layer of Velcor® hook adaptable fabric obtained from Gehring-Tricot Company, Garden City, N.Y.
FX1002-3D refers to a layer of flocked fabric—flocked with 100 Denier, 3 long Nylon Flock fibers—D=Double side flocked.
FX602-3S refers to a layer of flocked fabric—flocked with 60 Denier, 3 mm long Nylon Flock S=Single side flocked
FX452-35 refers to a layer of flocked fabric—flocked with 45 Denier, 3 mm long Nylon Flock fibers S=Single side flocked’
“//” refers to the presence of Divider Fabric between the two facing flocked surfaces. Divider/Separator Fabric is a thin plain weave fabric typically PET or Nylon.
For example, FX452-35 refers to a layer of flocked fabric—flocked with 45 Denier, 3 mm long Nylon Flock fibers S=Single side flocked.

### Impact Energy Absorbing Core Media Layer Results on FIF Layered Panels

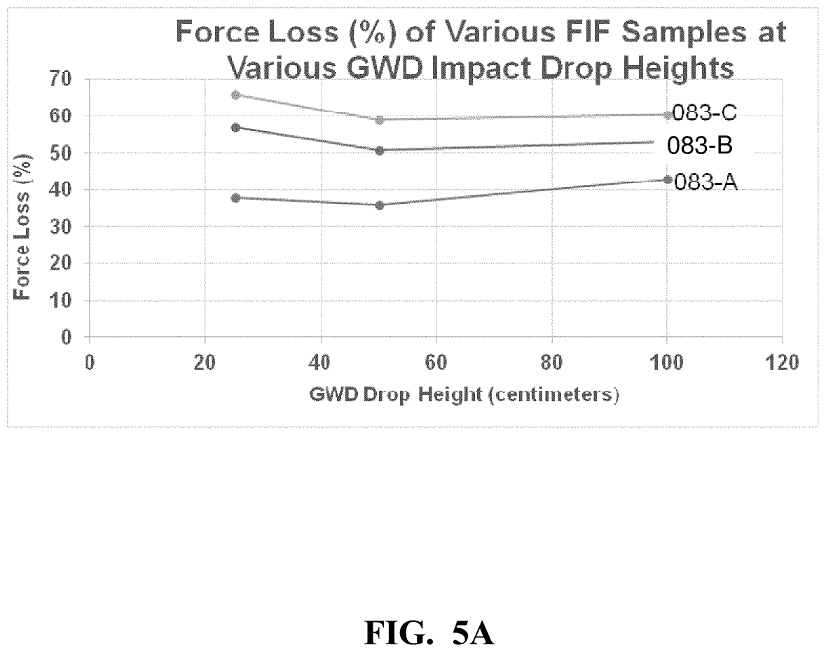

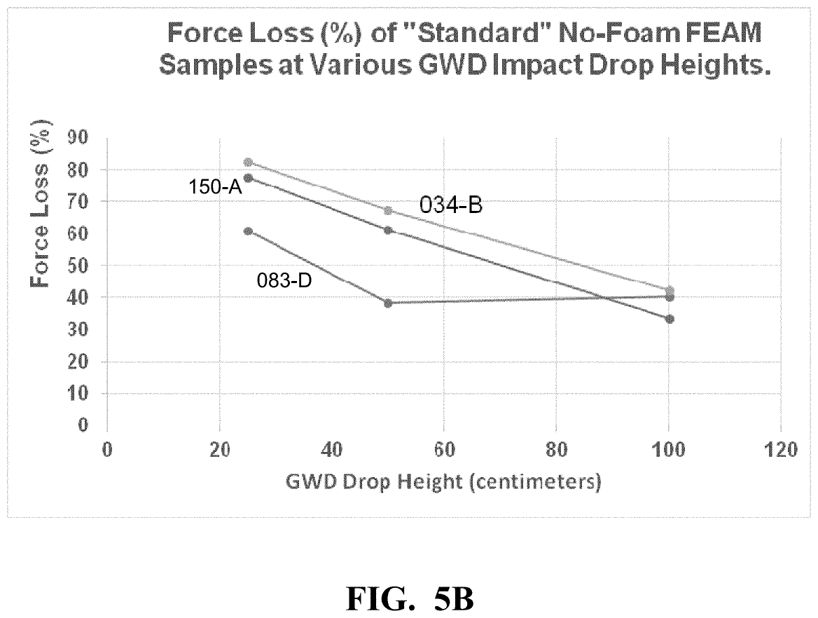

Table 2 below summarizes the GWD data obtained on three (3) laboratory fabricated FIF layered panel configurations. These samples employed three different two part polyurethane foam materials obtained from Reynolds Advanced Materials; FlexFoam-iT® Formulations—(1) 17; (2) 7FR and (3) IV. Table 2 presents GWD data for the three foam formulations and one (not foamed) flocked fabric (Control) at 25, 50 and 100 cm drop heights. These data show that test panel 083-C, prepared using the Reynolds IV foam formulation gave the best IFA behavior at all drop heights. The IFA properties of this 083-C panel were also better that those of the CONTROL (not foamed panel 083-D). Continuing this data analysis, we see that from an overall rating, the IFA properties of all the panels were get: 083-C>083-D>083-B>083-A. This IFA property behavior sequence follows directly in line with the technical data sheet reported density (specific gravity) of these various foam impregnating materials; FlexFoamiT® 17=0.27 g/cm3, FlexFoam-iT® 7FR=0.11 g/cm³, FlexFoam-iT® IV=0.06 g/cm³. The data indicates that the mechanical properties of the foam flock impregnation resin has a strong effect on the resulting IFA of the tested panels. Data shows that the lower density flexible foams, (lower than 0.11 g/cm³ and in the 0.06 g/cm³ range) are the flexible foam densities are the foam materials of choice for the fabrication of successful IFA performing FIF configuration BBA layer materials. Upon further review of the Table 2 data it is noted that, for some surprising reason, the changes in IFA properties of the FIF panels do not change much by the increase in GWD drop height; note that the higher the drop height the higher the kinetic energy level of the strike impact. Reviewing Table 2 data it is seen that the FL % and “g” values for these FIF panels at the 25 cm drop height are very close to those at the 100 cm drop height. This is an unusual and unexpected behavior. This suggests that these FIF panels are unique in their mechanical impact behavior. This behavior is apparently an inherent feature of these FIF IFA panels. These panels are capable of retaining their IFE properties/behavior over a wide impact (hit) velocity range. This should be an advantage when using FIF panels in BBA applications. This almost level IFA behavior of these FIF panels at various drop heights is clearly demonstrated in FIGS. 5A and 5B. Here, the plotted FIF's Force Loss % data in FIG. 5A are quite “flat” through the three GWD drop heights (25, 50 and 100 centimeters) employed. For comparison, FIG. 5B shows the plotted data for “traditional” (not-foam impregnated) FEAM panels data through the 25, 50 and 100 cm drop height range. Here the usual and expected downward trend in Force Loss % is seen as the drop height distance is increased. The difference in IFA behavior at various drop heights between the FIF panels and the traditional FEAM panels has been clearly demonstrated. The data presented in table 2 illustrates versatility of flocked surface IFE layer materials. While FIF configured IFE panels exhibit the unique feature of having fairly level Force Loss (FL) % to kinetic energy (drop height) increase behavioral properties it is noted that this behavior is accompanied by an increase in areal density of the fabricated panel. In other embodiments, FIF panels using lower density (specific gravity) foams are used. Various FlexFoam-iT formulation (III) having a 0.05 g/cm3 density; this density is slightly lower than the FlexFoam-iT IV material (density=0.06 g/cm3).

TABLE 2
Foam Impregnated Flock (FIF) FEAM Embodiments
Comparison of Force Loss (%) Properties of FIF Concept Panels and
“Standard” Configuration Panels at Various GWD Drop Heights.

| | | | Areal | | | | | | |
|---|---|---|---|---|---|---|---|---|---|
| | | Thickness | Density | “g” | FL % | “g” | FL % | “g” | FL % |
| Lab ID | Description | (mm) | (g/m²) | 25 cm | 25 cm | 50 cm | 50 m | 100 cm | 100 cm |
| 083-A | FIF-17/FIF-17/FIF-17 | 14.4 | 6611 | 47.1 ± 0.7 | 37.7 ± 1.0 | 75.6 ± 2.2 | 35.9 ± 2.2 | 94.8 ± 0.6 | 42.8 ± 0.4 |
| 083-B | FIF-7FR/FIF-7FR/FIF- | 14.4 | 5918 | 33.6 ± 0.3 | 57.0 ± 0.6 | 63.4 ± 1.7 | 50.7 ± 1.5 | 83.6 ± 0.6 | 53.0 ± 0.5 |
| | 7FR/FIF-7FR | | | | | | | | |
| 083-C | FIF-IV/FIF-IV/FIF-IV | 17.0 | 4445 | 28.5 ± 0.8 | 65.8 ± 0.4 | 54.4 ± 1.5 | 58.8 ± 1.1 | 74.4 ± 0.5 | 60.4 ± 0.3 |
| 083-D | LFF/LFF/LFF/LFF/LFF | 14.9 | 2934 | 30.3 ± 0.8 | 60.97 ± 1.3 | 72.0 ± 2.2 | 38.4 ± 2.2 | 95.1 ± 3.3 | 40.3 ± 2.5 |
| | Control | | | | | | | | |
| 150-A | VT/FX602-4D/VT | 13.8 | 2214 | 5.6 ± 0.5 | 77.7 ± 1 | 24.3 ± 2 | 61.2 ± 2 | 82.7 ± 2 | 33.6 ± 2 |
| 034-B | VT/FX1002-4D/VT | 15.5 | 2104 | 4.6 ± 0.5 | 82.6 ± 2 | 20.6 ± 1 | 67.4 ± 2 | 73.9 ± 1 | 42.1 ± 2 |

Table 2 notes: All test values are an average of at least three (3) replicate determinations;
This test samples are all 10 cm×10 cm (4″×4″);
The 25 cm, 50 cm and 100 cm values refer to drop height;
All these samples are wrapped with Micro-Suede fabric and perimeter sewn or fastened;
FIF signifies Foam Impregnated Flock: 17, 7FR and IV designate the type of Reynolds Advanced;
Materials foam—All two-part “Smooth-on” FlexFoam-IT types;
Control-no foam sample. LFF refers to in Room 019 Laboratory Flocked Fabric estimated to be 2.5 mm long and about 100 denier flock fiber; Appears to have broader +/− range of 2.5 mm flock fiber length—not exactly very uniform length flock.

While FIF configured IFA panels exhibit the unique feature of having fairly level FL % to kinetic energy (drop height) increase behavioral properties it is noted that this behavior is accompanied by an increase in areal density of the fabricated panel. Reynolds Advanced Materials has another FlexFoam-iT formulation (III) having a 0.05 g/cm3 density; this density is slightly lower than the FlexFoam-iT IV material (density=0.06 g/cm3) reported on in this study. In other embodiments, less dense flexible foam can be used because the lower the density of foam used in fabricating these FIF panels, the resulting areal density of the panel is lower.

From the foregoing it will be appreciated that the invention provides a new types of body armor and body armor components. The principles of the invention may be incorporated in various combinations of body armor panel configurations. The energy absorbing ATB panels can be used in combination with strike force panel and impact energy absorbing core media or can be used independently.

It is understood that although the embodiments described herein relate specifically to Conformable Ballistic (Protection) Body Armor, the principles, practice and designs described herein are also useful in other applications. All literature and similar material cited in this application, including, patents, patent applications, articles, books, treatises, dissertations and web pages, regardless of the format of such literature and similar materials, are expressly incorporated by reference in their entirety. In the event that one or more of the incorporated literature and similar materials differs from or contradicts this application, including defined terms, term usage, described techniques, or the like, this application controls.

The section headings used herein are for organizational purposes only and are not to be construed as limiting the subject matter described in any way. While the present invention has been described in conjunction with various embodiments and examples, it is not intended that the present teachings be limited to such embodiments or examples. On the contrary, the present invention encompasses various alternatives, modifications, and equivalents, as will be appreciated by those of skill in the art. While the teachings have been particularly shown and described with reference to specific illustrative embodiments, it should be understood that various changes in form and detail may be made without departing from the spirit and scope of the teachings. Therefore, all embodiments that come within the scope and spirit of the teachings, and equivalents thereto are claimed. The descriptions and diagrams of the methods of the present teachings should not be read as limited to the described order of elements unless stated to that effect. One skilled in the art will appreciate further features and advantages of the present disclosure based on the above-described embodiments. All publications and references cited herein are expressly incorporated herein by reference in their entirety.

What is claimed is:

1. An impact energy dissipating fabric system comprising:
a strike-face layer comprising a Z-axis flock fiber reinforced Organic Polymer Laminar Composite (OPLC);
an Impact Energy Absorbing (IEA) core media layer attached adjacent the strike-face layer; and
an Against-The-Body (ATB) layer attached adjacent the impact energy absorbing core media layer.

2. The impact energy dissipating fabric system according to claim 1, wherein the Z-axis flock fiber reinforced OPLC comprises a plurality of layers of ballistic impact resistant fabric in a resin matrix comprising one of:
epoxy;
a polyurea resin;
a polyurethane resin; and
a polyurea/polyurethane hybrid.

3. The impact energy dissipating fabric system according to claim 2, wherein the plurality of layers of ballistic impact resistant fabric in a matrix are separated into a plurality of slats of Z-axis flock fiber reinforced OPLC; and
wherein the strike-face layer further comprises a fabric base layer attached adjacent to the plurality of slats of Z-axis flock fiber reinforced OPLC in a closely spaced arrangement to provide flexibility and directional conformability.

4. The impact energy dissipating fabric system according to claim 2, wherein the plurality of layers of ballistic impact resistant fabric comprise spun yarn fabric of liquid crystal polymer (LCP).

5. The impact energy dissipating fabric system according to claim 1, wherein the impact energy absorbing (IEA) core media layer comprises at least one Foam Impregnated Flocked (FIF) layer comprising a plurality of flock fibers embedded in an energy absorbing, flexible foam matrix.

6. The impact energy dissipating fabric system according to claim 5, wherein the at least one Foam Impregnated Flocked (FIF) layer comprises flock fibers having a denier in a range of about 2 to 100 and a length of about 1 to 4 mm long.

7. The impact energy dissipating fabric system according to claim 6, wherein the flock fibers include one of:
nylon fibers; and
polyester fibers.

8. The impact energy dissipating fabric system according to claim 1 wherein the impact energy absorbing (IEA) core media layer comprises at least one layer of polyolefin based ballistic impact resistant fabric.

9. The impact energy dissipating fabric system according to claim 1, wherein the ATB layer comprises:
a flocked velvety faced fabric panel;
a separator fabric layer disposed adjacent the flocked velvety faced fabric panel;
at least one single sided flocked fabric layer disposed adjacent to the separator fabric layer; and
one side of a hook layer or loop attachment system disposed adjacent the at least one single sided flocked fabric layer.

10. The impact energy dissipating fabric system according to claim 9, wherein the at least one single sided flocked fabric layer comprises a Flocked Energy Absorbing Material (FEAM) panel comprising flock fibers having a denier of about 45 to 100 and length of about 1-4 mm flock fibers flocked on a plain weave fabric base.

11. The impact energy dissipating fabric system according to claim 1, wherein the impact energy dissipating fabric system is assembled into protection equipment selected from the group consisting of vests, helmets, body armor, knee pads, footwear, vehicle lining, casings and other types of protective linings for a human body, electronics and other goods, abrasion resistant gear, impact resistant gear and trauma gear.

12. A method of making an impact energy dissipating fabric system comprising:
assembling a strike-face layer comprising a Z-axis flock fiber reinforced Organic Polymer Laminar Composite (OPLC);
assembling an impact energy absorbing (IEA) core media layer;
attaching the IEA core media layer to the strike-face layer;
assembling an Against-The-Body (ATB) layer; and
attaching the ATB layer adjacent to the IEA core media layer.

13. The method of claim 12, wherein attaching the IEA core media layer to the strike-face layer comprises one of:
adhesively bonding the IEA core media layer to the strike-face layer;
attaching the IEA core media layer to the strike-face layer with a hook and loop attachment system;
fastening the strike-face layer and the IEA core media layer together.
wherein attaching the ATB layer adjacent to the IEA core media layer comprises one of:
adhesively bonding the IEA core media layer to the ATB layer;
attaching the IEA core media layer to the ATB layer with a hook and loop attachment system; and
fastening the strike-face layer, ATB layer and the IEA core media layer together.

14. The method of claim 12, wherein assembling a strike-face layer comprising a Z-axis flock fiber reinforced Organic Polymer Laminar Composite (OPLC) comprises
flocking a plurality of ballistic impact resistant fabric layers;
applying a resinous matrix material to the plurality of flocked ballistic impact resistant fabric layers;
curing the resinous matrix material;
cutting the plurality of flocked ballistic impact resistant fabric layers into a plurality of slats;
arranging the plurality of slats closely together side by side; and
bonding the plurality of slats to a base fabric.

15. The method of claim 14, wherein bonding the plurality of slats to a base fabric comprises bonding the plurality of slats to the base fabric with an elastomeric adhesive.

16. The method of claim 14, wherein assembling a strike-face layer comprising a Z-axis flock fiber reinforced Organic Polymer Laminar Composite (OPLC) comprises:
separating the plurality of slats to provide flexibility and directional flexibility and conformability.

17. The method of claim 12, wherein assembling an ATB layer comprises:
flocking a fabric base to make a flocked velvet panel;
attaching a separator fabric layer to the flocked velvet panel;
flocking at least one single sided flocked fabric layer; and
attaching the at least one single sided flocked fabric layer to the separator fabric layer, the separator fabric layer disposed between the flocked velvet panel and at least one single sided flocked fabric layer.

18. The method of claim 17, further comprising:
attaching one side of a hook or loop attachment system adjacent the at least one plain weave fabric layer.

19. The method of claim 17, wherein the single sided flocked fabric layer comprises a flocked plain weave fabric base.

20. The method of claim 12, wherein assembling an impact energy absorbing (IEA) core media layer comprises:
providing a flocked fabric having a flocked surface;
mixing a foam resin to provide a rapidly expanding and curing foam;
impregnating the flocked surface with the rapidly expanding and curing foam; and
processing the rapidly curing foam such that the core media layer has a fairly uniform thickness.

21. An impact energy dissipating fabric system comprising:
an Against-The-Body (ATB) layer attached adjacent the impact energy absorbing core media layer comprising:
a flocked velvety faced fabric panel;
a separator fabric layer disposed adjacent the flocked velvety faced fabric panel;
at least one single sided flocked fabric layer disposed adjacent to the separator fabric layer; and
one side of a hook and loop attachment system disposed adjacent the at least one single sided flocked fabric layer.
